(19) United States
(12) Patent Application Publication
(10) Pub. No.: US 2023/0325476 A1
(43) Pub. Date: Oct. 12, 2023

(54) OBFUSCATION DEVICE, OBFUSCATION METHOD, AND OBFUSCATION PROGRAM

(71) Applicant: NIPPON TELEGRAPH AND TELEPHONE CORPORATION, Tokyo (JP)

(72) Inventors: Yuma KUROGOME, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/020,626

(22) PCT Filed: Sep. 10, 2020
(86) PCT No.: PCT/JP2020/034332

§ 371 Date: Feb. 10, 2023

(51) Int. Cl. G06F 21/14

(52) U.S. Cl. CPC G06F 21/14

(57) ABSTRACT

An obfuscation device (10) includes an analyzing unit (141) that converts first binary data output as an executable file into a first intermediate representation, a rewriting unit (142) that inserts a predetermined code called when the first binary data is output into the first intermediate representation acquired from the analyzing unit (141) and rewrites the first intermediate representation into a second intermediate representation, and an output unit (1413) that reads the predetermined code inserted by the rewriting unit (142), converts the second intermediate representation into executable second binary data, and outputs the second binary data when the second intermediate representation is to he converted into binary data.

### TECHNICAL FIELD

The present invention relates to an obfuscation device, an obfuscation method, and an obfuscation program.

### BACKGROUND ART

In the related art, analyzing how binary data to be analyzed calls what application programming interface (API) (which may be referred to as an “API call” below) has played an important role in program analysis. In addition, in order to analyze an API call, it is necessary to discover the boundary between a program to be analyzed and the API (which may be referred to as a “hook point” below). In other words, because a hook point is determined at the time of linking, it is necessary to find it later. The insight about the internal structure of the program is obtained when an API call is analyzed, and thus the author has motivation to obfuscate the API call.

A number of API call obfuscation techniques have been proposed so far. These include, for example, an API location obfuscation technique, a Dynamic Link Library (DLL) location obfuscation technique, and the like. These techniques make reference to the dynamically linked library files and the APIs in the library files complicated.

### CITATION LIST

### Non Patent Literature

[NPL 1] Yuhei Kawkova, 2019, “Taint-based analysis Technologies against Evasive Malware,” Waseda University.

### SUMMARY OF INVENTION

### Technical Problem

However, in the related art, an API call using binary data cannot be sufficiently obfuscated. For example, the related art described above is not robust with respect to an analysis method using an approach based on taint propagation or the like (for example, refer to NPL 1). The reason for this is that, in the related art, dynamic linking is generally used, binary data is referred to when a library file is to be executed, which enables the library file to be tracked, and thus a hook point can be searched for even when an API call is obfuscated.

### Solution to Problem

To solve the above-described problems, the present invention includes an analyzing unit that converts first binary data output as an executable file into a first intermediate representation, a rewriting unit that inserts a predetermined code called when the first binary data is output into the first intermediate representation acquired from the analyzing unit and rewrites the first intermediate representation into a second intermediate representation, and an output unit that reads the predetermined code inserted by the rewriting unit, converts the second intermediate representation into executable second binary data, and outputs the second binary data when the second intermediate representation is to be converted into binary data.

### ADVANTAGEOUS EFFECTS OF INVENTION

The present invention can sufficiently obfuscate an API call using binary data.

### BRIEF DESCRIPTION OF DRAWINGS

FIG. 1 is a block diagram illustrating a configuration example of an obfuscation device according to a first embodiment.

FIG. 2 is a diagram illustrating an example of a flow of processing by an analyzing unit according to the first embodiment.

FIG. 3 is a diagram illustrating an example of a flow of processing by a rewriting unit according to the first embodiment.

FIG. 4 is a diagram illustrating an example of a flow of processing by an output unit according to the first embodiment.

FIG. 5 is a diagram illustrating an example of in-line expansion according to the first embodiment.

FIG. 6 is a flowchart showing an example of a flow of obfuscation process according to the first embodiment.

FIG. 7 is a diagram illustrating a computer that executes a program.

### DESCRIPTION OF EMBODIMENTS

An embodiment of an obfuscation device, an obfuscation method, and an obfuscation program according to the present invention will be described below in detail based on the drawings. Further, the present invention is not limited by the embodiment described below.

### First Embodiment

Hereinafter, a configuration of an obfuscation device according to the present embodiment, processing by an analysing unit, processing by a rewriting unit, processing by an output unit, and a flow of an obfuscation process will be described in order, and the effects of the present embodiment will be described at the end.

### Configuration of Obfuscation Device

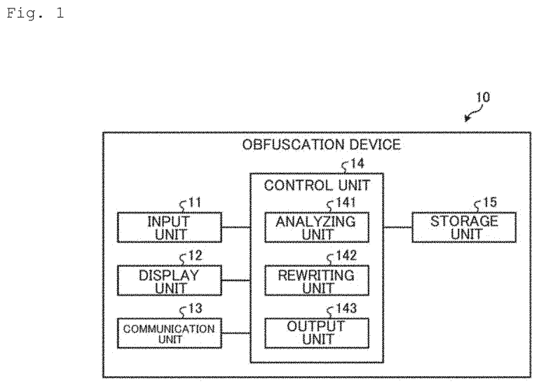

A configuration of an obfuscation device 10 according to the present embodiment will be described using FIG. 1. FIG. 1 is a block diagram illustrating a configuration example of an obfuscation device according to a first embodiment. The obfuscation device 10 has an input unit 11, a display unit 12, a communication unit 13, a control unit 14, and a storage unit 15.

The input unit 11 inputs various types of information to the obfuscation device 10. The input unit 11 includes input devices, for example, a touch panel, a voice input device, a keyboard, a mouse, and the like. The display unit 12 outputs various types of information from the obfuscation device 10. The display unit 12 includes, for example, a display device such as a liquid crystal display, a printing device such as a printer, an information communication device, or the like.

The communication unit 13 performs data communication with another device. The communication unit 13 performs data communication with other communication devices, for example. Further, the communication unit 13 can perform data communication with a terminal of an operator, which is not illustrated.

The control unit 14 controls the entirety of the obfuscation device 10. The control unit 14 includes an analyzing unit 141, a rewriting unit 142, and an output unit 143. Here, the control unit 14 is, for example, an electronic circuit such as a central processing unit (CPU) or a micro processing unit (MPU), or an integrated circuit such as an application specific integrated circuit (ASIC) or a field programmable gate array (FPGA).

The analyzing unit 141 converts first binary data 20 output as an executable file into a first intermediate representation 22. For example, the analyzing unit 141 converts the first binary data 20 into the first intermediate representation 22 by using an inverse assembler 141a. In addition, the analyzing unit 141 converts an API called when the first binary data 20 is output into a third intermediate representation 32 by using the inverse assembler 141a. Detailed description of the processing by the analyzing unit 141 will be described later.

Further, the above-described binary data may be a file in which binary data is stored, that is, a binary file, and is not particularly limited. In addition, although the above-described predetermined code is, for example, an original code of an API included in a library file referred to at the time of linking, or the like, it is not particularly limited.

The rewriting unit 142 inserts the predetermined code called when the first binary data 20 is output into the first intermediate representation 22 acquired from the analyzing unit 141, and rewrites the first intermediate representation into a second intermediate representation 40. For example, the rewriting unit 142 inserts the API called when the first binary data 20 is output into the first intermediate representation 22 acquired from the analyzing unit 141 by means of in-line expansion, and rewrites the first intermediate representation into the second intermediate representation 40. In addition, the rewriting unit 142 inserts an API called based on dynamic linking when the first binary data 20 is output by means of in-line expansion and rewrites the API into the second intermediate representation 40 which is eligible for static linking. Detailed description of the processing by the rewriting unit 142 will be described later.

When the second intermediate representation 40 is to be converted into binary data, the output unit 143 reads the predetermined code inserted by the rewriting unit 142, converts the second intermediate representation 40 into executable second binary data 70, and outputs the second binary data 70. For example, the output unit 143 converts the second intermediate representation 40 into the second binary data 70 based on static linking and outputs the second binary data 70. In addition, the output unit 143 calls an API different from the API inserted into the first intermediate representation 22 based on dynamic linking. Detailed description of the processing by the output unit 143 will be described later.

The storage unit 15 stores various types of information referred to by the control unit 14 for operations and various types of information acquired by the control unit 14 while it is operating. Here, the storage unit 15 is, for example, a semiconductor memory element such as a random access memory (RAM) or a flash memory, or a storage device such as a hard disk or an optical disc. Further, although the storage unit 15 is installed inside the obfuscation device 10 in the example of FIG. 1, it may be installed outside the obfuscation device 10. In addition, a plurality of storage units may be installed.

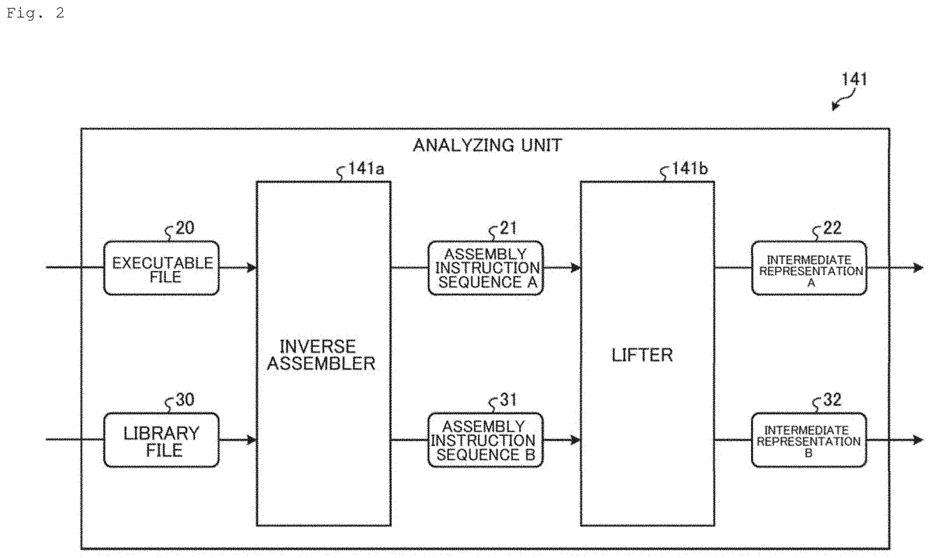

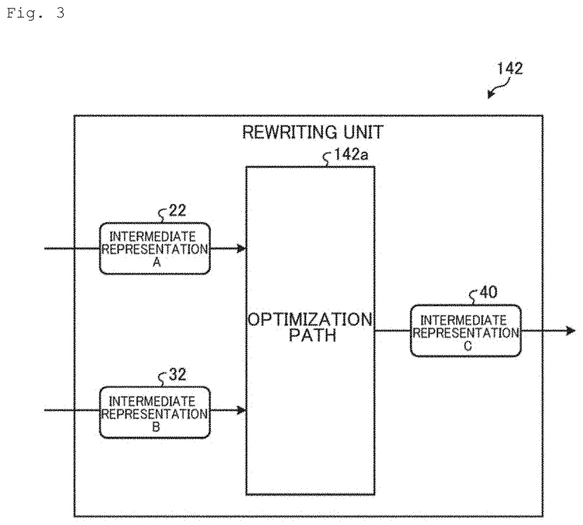

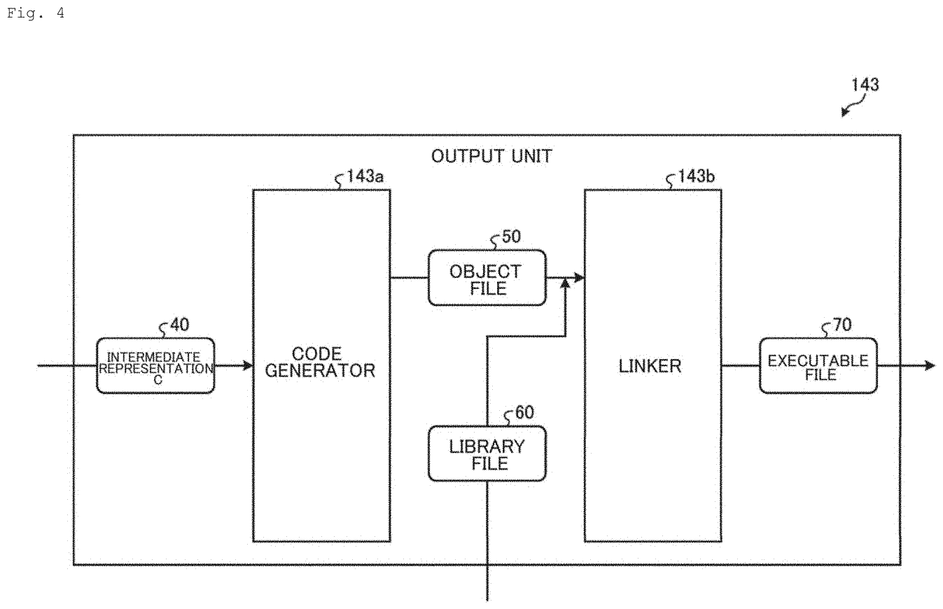

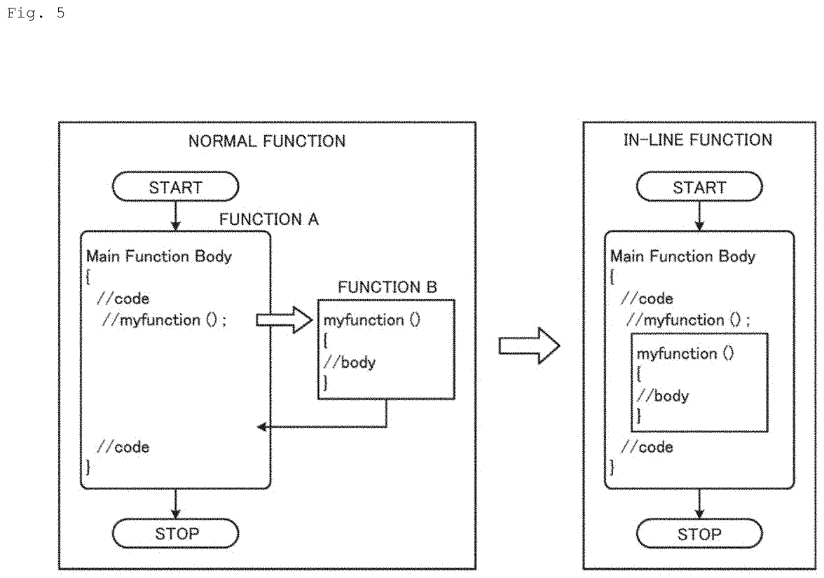

Next, a general obfuscation process and the like will be described, and then a flow of each process of the obfuscation device 10 according to the present embodiment will be described using FIGS. 2 to 5. FIG. 2 is a diagram illustrating an example of the flow of the processing by the analyzing unit according to the first embodiment. FIG. 3 is a diagram illustrating an example of the flow of the processing by the rewriting unit according to the first embodiment. FIG. 4 is a diagram illustrating an example of the flow of the processing by an output unit according to the first embodiment. FIG. 5 is a diagram illustrating an example of in-line expansion according to the first embodiment.

The general obfuscation process is performed as one of various optimization operations for intermediate representation in the course of the process of inputting a source code and outputting an object file (compiling) using a compiler. For example, a source code is converted into a token sequence by a lexical analyzer, the token sequence is converted into an abstract syntax tree by a syntax analyzer, the abstract syntax tree is converted into an intermediate representation by a semantic analyzer, the intermediate representation is optimized using an optimization path, and the optimized intermediate representation is converted into an object file by a code generator. In this course, a method for enhancing the efficiency of a program and a method for applying obfuscation to the program can be applied to the intermediate representation.

In addition, a general linking process is a process of inputting an object file and a library file and outputting binary data as an executable file using a linker. The library file includes, as a function provided by an operating system, an API which is a function of file input/output or the like.

Here, there are two types of linking which are static linking and dynamic linking, and dynamic linking is generally used. Static linking is a linking system in which an API itself included in a library file is embedded in binary data, and the API can be executed even in an environment with no library files. On the other hand, dynamic linking is a linking system in which an external reference for a library file is embedded in binary data, the name of the library file and the name of the API desired to be used are embedded in the external reference, and a program is executed after the library file and the API are automatically retrieved for program execution.

In addition, binary re-rewriting is a process of inputting binary data and outputting binary data with some of functions rewritten. Specifically, when an intermediate representation is restored from binary data by means of a binary analysis tool or the like using an inverse assembler or the like and the intermediate representation restored here is given to an optimization path of a compiler, a program optimization method or an obfuscation method can be applied similarly to the compiler. After the process such as the optimization, and the like, the binary data is output using a linker.

With respect to the above-described obfuscation process, the existing techniques are performed based on dynamic linking which is a technique of loading the original code of the API included in the library file at the time of execution, and thus the dynamic linking is vulnerable to program analysis or the like. For this reason, the obfuscation device 10 according to the present embodiment is able to remake data using static linking that is a technique of not loading the original code of the API included in the library file at the time of execution. Specifically, the obfuscation device 10 uses a binary re-rewrite technique to transplant the original code of the dynamically linked API in binary data that calls the original code from the library file and remakes the data into binary data to which static linking has been applied.

### Flow of Processing by Analyzing Unit

Firstly, the flow of processing by the analyzing unit according to the present embodiment will be described using FIG. 2. First, binary data (first binary data) 20 output as an executable file and an API 30 included in a library file are taken into the analyzing unit 141 of the control unit 14 through the input unit 11 of the obfuscation device 10.

Then, the first binary data 20 and the API 30 are converted into an assembly instruction sequence A 21 and an assembly instruction sequence B 31 through the inverse assembler 141a. Finally, the assembly instruction sequence A 21 and the assembly instruction sequence B 31 are converted into an intermediate representation A (a first intermediate representation) 22 and an intermediate representation B 32 (a third intermediate representation), respectively, via a lifter 141b, and transmitted to the rewriting unit 142.

Here, all APIs included in the library file may be converted into an intermediate representation B through processing by the inverse assembler 141a and the lifter 141b. In addition, some of the APIs included in the library file may be converted into the intermediate representation B, or the APIs may not be converted into the intermediate representation B.

### Flow of Processing by Rewriting Unit

Secondly, the flow of processing by the rewriting unit according to the present embodiment will be described in detail using FIG. 3. First, the intermediate representation. A 22 and the intermediate representation B 32 transmitted by the analyzing unit 141 are taken to the rewriting unit 142.

Next, the intermediate representation A 22 and the intermediate representation B 32 are rewritten to be an intermediate representation C 40 which is an optimized intermediate representation via an optimization path 142a of the rewriting unit 142. Here, the intermediate representation B 32 based on the API 30 is inserted into the intermediate representation A 22 based on the first binary data 20 by means of in-line expansion, which will be described later, and thereby an intermediate representation C (a second intermediate representation) 40 is generated. Finally, the generated intermediate representation C 40 is transmitted to the output unit 143.

Further, the processing performed for the generation of the intermediate representation C 40 is not limited to in-line expansion. A method for enhancing the efficiency of a program other than in-line expansion or a method for applying obfuscation to the program may be performed as an optimization process through The optimization path 142a.

Furthermore, in-line expansion according to the present embodiment will be described in detail using FIG. 5. In-line expansion is one of program optimization methods applicable to intermediate representations, and is a technique of embedding a function B called by a certain function A in the function A.

In a flow using a normal function, the function B required for executing the certain function A is outside the function A, and a process of calling the function B is performed when the function A is executed or the like (see the normal function in FIG. 5). On the other hand, in the function that has undergone in-line expansion (an in-line function), by describing the function B in the function A, the process of calling the function B when the function A is executed, or the like is unnecessary (see the in-line function of FIG. 5).

In the present embodiment, the intermediate representation C 40 which does not require an API call to the outside at the time of execution is generated by describing the intermediate representation B 32 based on the API 30 in the intermediate representation A 22 based on the first binary data 20.

### Flow of Processing by Output Unit

Thirdly, the flow of processing by the output unit according to the present embodiment will be described using FIG. 4. First, the intermediate representation C 40 transmitted by the rewriting unit 142 is taken to the output unit 143.

Next, the intermediate representation C 40 is converted into an object file 50 through a code generator 143a of the output unit 143. Finally, the object file 50 is output as binary data (second binary data) 70 that is an executable file based on the inserted API 30 through a linker 143b, and is processed for display through a display unit 12.

Further, the object file 50 may be called when the first binary data 20 is output, and refer to a library file 60 including an API different from the inserted API to be output as binary data 70 which is an executable file through the linker 143b.

### Procedure of Obfuscation Process

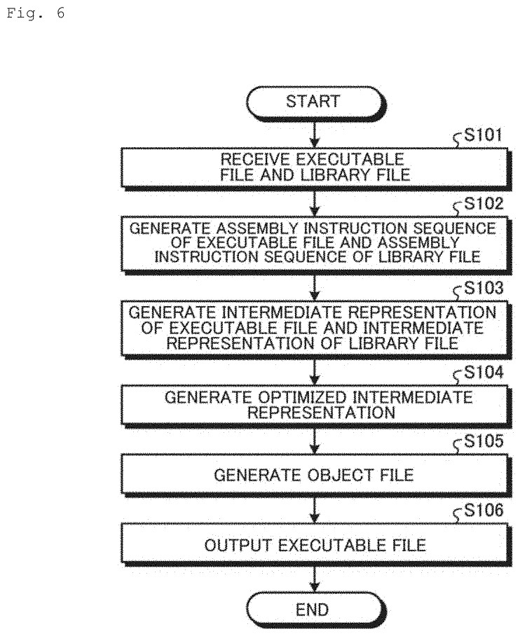

An example of a procedure of the obfuscation process according to the present embodiment will be described using FIG. 6. FIG. 6 is a flowchart showing an example of a flow of the obfuscation process according to the first embodiment. First, the analyzing unit 141 of the control unit 14 receives an executable file 20 including binary data and a library file 30 including an API as shown in FIG. 6 (step S101).

Next, the inverse assembler 141a of the analyzing unit 141 generates an assembly instruction sequence A 21 from the executable file 20. In addition, the inverse assembler 141a of the analyzing unit 141 generates an assembly instruction sequence B 31 from the library file 30 (step S102). Further, the assembly instruction sequence A 21 and the assembly instruction sequence B 31 may be generated simultaneously. In addition, the generation of the assembly instruction sequence A 21 may be performed prior to the generation of the assembly instruction sequence B 31, or the generation of the assembly instruction sequence B 31 may be performed prior to the generation of the assembly instruction sequence A 21.

Then, the lifter 141b of the analyzing unit 141 generates an intermediate representation A 22 from the assembly instruction sequence A 21. In addition, the lifter 141b of the analyzing unit 141 generates an intermediate representation B 32 from the assembly instruction sequence B 31 (step S103). Further, the intermediate representation A 22 and the intermediate representation B 32 may be generated simultaneously. Furthermore, the generation of the intermediate representation A 22 may be performed prior to the generation of the intermediate representation B 32, or the generation of the intermediate representation B 32 may be performed prior to the generation of the intermediate representation A 22.

Subsequently, the optimization path 142a of the rewriting unit 142 inserts the intermediate representation B 32 acquired from the analyzing unit 141 into the intermediate representation A 22 acquired from the analyzing unit 141 by means of in-line expansion to generate the optimized intermediate representation C 40 (step S104).

Next, the code generator 143a of the output unit 143 generates an object file 50 from the intermediate representation C 40 acquired from the rewriting unit 142 (step S105). Finally, the linker 143b of the output unit 143 generates an executable file 70 including binary data from the object file 50 (step S106), and the process ends.

### Effects of First Embodiment

Firstly, the obfuscation device 10 according to the above-described present embodiment converts the first binary data 20 output as an executable file into the first intermediate representation 22, inserts a predetermined code called when the first binary data 20 is output into the acquired first intermediate representation 22, and rewrites the first intermediate representation as the second intermediate representation 40, and reads the inserted predetermined code, converts the second intermediate representation 40 into executable second binary data 70, and outputs the executable second binary data 70 when the second intermediate representation 40 is to be converted into binary data. Thus, calling of the predetermined code using the binary data can be sufficiently obfuscated.

Secondly, the obfuscation device 10 inserts the API called when the first binary data 20 is output into the acquired first intermediate representation 22 by means of in-line expansion, and rewrites the API into the second intermediate representation 40. Thus, the API call using the binary data can be sufficiently obfuscated.

Thirdly, the obfuscation device 10 inserts the API called based on dynamic linking when the first binary data 20 is output by means of in-line expansion, rewrites the API into the second intermediate representation 40 that is eligible for static linking, converts the second intermediate representation 40 into the second binary data 70 based on the static linking, and outputs the second binary data 70. Thus, it makes difficult to find a hook point, an API call using the binary data can be made more obfuscated, and further illegal copy of original logic included in software and illegal use of software without permitted license can be prevented.

Fourthly, the obfuscation device 10 converts the first binary data 20 into the first intermediate representation 22 using the inverse assembler. Thus, it makes more difficult to find a hook point, and an API call using the binary data can be made further obfuscated.

Fifthly, the obfuscation device 10 converts an API called when the first binary data 20 is output into the third intermediate representation 32 using the inverse assembler. Thus, it makes more difficult to find a hook point, and an API call using the binary data can be made further obfuscated.

Sixthly, the obfuscation device 10 calls an API different from the API inserted into the first intermediate representation 22 using dynamic linking. Thus, the API that is not eligible for static linking can be called.

### System Configuration, Etc.

Each component of each device illustrated according to the above-described embodiment is a functional concept and needs not necessarily be physically configured as shown. That is, the specific forms of distribution and integration of the devices are not limited to the forms illustrated in the figure, and all or part of them can be configured by functionally or physically distributing and integrating them in any unit according to various loads, use situations, or the like. In addition, all or any part of the processing functions performed by the devices may be achieved by a CPU and programs analyzed and executed by the CPU or achieved as the wired logic of hardware.

Also, among the processes described in the present embodiment, all or some processes that are described as being automatically executed may also be manually executed, or all or some of processes that are described as being manually executed may also be automatically executed using a known method. In addition, the processing procedure, the control procedure, specific names, information including various data and parameters that are shown in the above document and drawings may be arbitrarily changed unless otherwise described.

### Program

In addition, a program that describes processes executed by the obfuscation device 10 described in the above embodiment in a computer-executable language may be created. In this case, the same effects as in the above embodiment may be exhibited by a computer executing the program. Furthermore, processes similar to those of the foregoing embodiment may be also realized by recording the creation program in a computer-readable recording medium, and causing a computer to load and execute the creation program recorded in this recording medium.

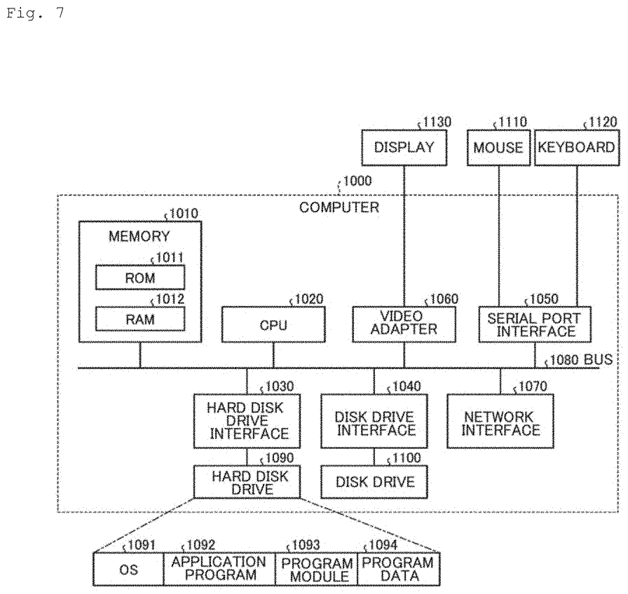

FIG. 7 is a diagram illustrating a computer that executes a program. As illustrated in FIG. 7, a computer 1000 has, for example, a memory 1010, a central processing unit (CPU) 1020, a hard disk drive interface 1030, a disk drive interface 1040, a serial port interface 1050, a video adapter 1060, and a network interface 1070, and these units are connected to each other via a bus 1080.

The memory 1010 includes a read only memory (ROM) 1011 and a RAM 1012 as illustrated in FIG. 7. The RCM 1011 stores, for example, a boot program such as a basic input/output system (BIOS). The hard disk drive interface 1030 is connected to a hard disk drive 1090 as illustrated in FIG. 7. The disk drive interface 1040 is connected to a disk drive 1100 as illustrated in FIG. 7. For example, a removable storage medium such as a magnetic disk or an optical disc is inserted in the disk drive 1100. The serial port interface 1050 is connected to, for example, a mouse 1110 and a keyboard 1120 as illustrated in FIG. 7. The video adapter 1060 is connected to, for example, a display 1130 as illustrated in FIG. 7.

Here, the hard disk drive 1090 stores, for example, an OS 1091, an application program 1092, a program module 1093, and program data 1094 as illustrated in FIG. 7. That is to say, the above-described program is stored in, for example, the hard disk drive 1090 as a program module containing instructions to be executed by the, computer 1000.

Moreover, various types of data described in the foregoing embodiment may be stored, as program data, in the memory 1010 or the hard disk drive 1090, for example. In addition, the CPU 1020 reads the program module 1093 or the program data 1094 stored in the memory 1010 or the hard disk drive 1090 onto the RAM 1012 as needed, and executes various types of processing procedures.

Further, the program module 1093 and the program data 1094 related to the program need not be stored in the hard disk drive 1090, and may also be stored in, for example, a removable storage medium and loaded by the CPU 1020 via a disk drive or the like. Alternatively, the program module 1093 and the program data 1094 related to the program may also be stored in another computer that is connected via a network (a local area network (LAN), a wide area network (WAN), or the like) and loaded by the CPU 1020 via the network interface 1070.

The above-described embodiment and modification thereof are included in the technology disclosed by the present application, as well as in the scope of the invention described in the claims and the equivalent range.

### REFERENCE SIGNS LIST

10 Obfuscation device

11 Input unit

12 Display unit

13 Communication unit

14 Control unit

141 Analyzing unit

141a Inverse assembler

141b Lifter

142 Rewriting unit

142a Optimization path

143 Output unit

143a Code generator

143h Linker

15 Storage unit

20, 70 Executable file

21 Assembly instruction sequence A

22 Intermediate representation A

30, 60 Library files

31 Assembly instruction sequence B

32 Intermediate representation B

40 Intermediate representation C

50 Object file

1. An obfuscation device, comprising:
analyzing circuitry configured to convert first binary data output as an executable file into a first intermediate representation;
rewriting circuitry configured to insert a predetermined code called when the first binary data is output into the first intermediate representation acquired from the analyzing circuitry and rewrite the first intermediate representation into a second intermediate representation; and
output circuitry configured to read the predetermined code inserted by the rewriting circuitry, convert the second intermediate representation into executable second binary data, and output the second binary data when the second intermediate representation is to be converted into binary data.

2. The obfuscation device according to claim 1, wherein;
the rewriting circuitry inserts an application programming interface (API) called when the first binary data is output into the first intermediate representation acquired from the analyzing circuitry by in-line expansion, and rewrites the first intermediate representation into the second intermediate representation.

3. The obfuscation device according to claim 2, wherein:
the rewriting circuitry inserts the API called based on dynamic linking when the first binary data is output by means of in-line expansion and rewrites the API into the second intermediate representation that is eligible for static linking, and the output circuitry converts the second intermediate representation into the second binary data based on static linking and outputs the second binary data.

4. The obfuscation device according to claim 1, wherein:
the analyzing circuitry converts the first binary data into the first intermediate representation using an inverse assembler.

5. The obfuscation device according to claim 3, wherein:
the analyzing circuitry converts the API called when the first binary data is output into a third intermediate representation using an inverse assembler.

6. The obfuscation device according to claim 2, wherein:
the output circuitry calls an API different from the API inserted into the first intermediate representation based on dynamic linking.

7. An obfuscation method, comprising:
converting first binary data output as an executable file into a first intermediate representation;
inserting a predetermined code called when the first binary data is output into the first intermediate representation and rewriting the first intermediate representation into a second intermediate representation; and
reading the inserted predetermined code, converting the second intermediate representation into executable second binary data, and outputting the second binary data when the second intermediate representation is to be converted into binary data.

8. A non-transitory computer readable medium storing an obfuscation program causing a computer to execute:
converting first binary data output as an executable file into a first intermediate representation;
inserting a predetermined code called when the first binary data is output into the first intermediate representation and rewriting the first intermediate representation into a second intermediate representation; and
reading the inserted predetermined code, converting the second intermediate representation into executable second binary data, and outputting the second binary data when the second intermediate representation is to be converted into binary data.
